(19) United States
(12) Patent Application Publication
(10) Pub. No.: US 2025/0214662 A1
(43) Pub. Date: Jul. 3, 2025

(54) MOVING STRUCTURE FOR A REPLACEABLE PART AND A MOVING SYSTEM INCLUDING THE SAME

(71) Applicants: HYUNDAI MOTOR COMPANY, Seoul (KR); KIA CORPORATION, Seoul (KR)

(72) Inventors: Jaeseung Lee, Hwaseong-si (KR); Joonghyun Shin, Hwaseong-si (KR); Won Ki Song, Hwaseong-si (KR); Sun Hyung Cho, Hwaseong-si (KR); Dae Hee Lee, Hwaseong-si (KR); Jin Ho Hwang, Hwaseong-si (KR); Soo Bok Kim, Hwaseong-si (KR); Hyungsik Choi, Hwaseong-si (KR)

(73) Assignees: HYUNDAI MOTOR COMPANY, Seoul (KR); KIA CORPORATION, Seoul (KR)

(21) Appl. No.: 18/962,756

(22) Filed: Nov. 27, 2024

(30) Foreign Application Priority Data
Dec. 28, 2023 (KR) 10-2023-0194788

(51) Int. Cl. B62D 63/04

(52) U.S. Cl. CPC B62D 63/04

(57) ABSTRACT

A moving structure for a replaceable part of a vehicle, which includes a fixed part fixed to an under body and a replaceable part that is detachable from the fixed part. The moving structure includes replaceable part docking coupling members connected to the lower sides on both sides of the replaceable part in the vehicle width direction, replaceable part guide units installed in the under body to guide the replaceable part along the front and rear direction of the vehicle body by docking connection with the replaceable part docking coupling members along the vertical direction, and a rack gear mounted on the lower part of the replaceable part and positioned along the front and rear direction of the vehicle body.

### CROSS-REFERENCE TO RELATED APPLICATION

This application claims priority to and the benefit of Korean Patent Application No. 10-2023-0194788, filed in the Korean Intellectual Property Office on Dec. 28, 2023, the entire contents of which are incorporated herein by reference.

### BACKGROUND

### (a) Field

The present disclosure relates to a moving structure for a replaceable part of a vehicle. More particularly, the present disclosure relates to a moving structure for a replaceable part and moving system that enable the replacement of a replaceable part that can be changed according to the purpose of use of the vehicle.

### (b) Description of the Related Art

Recently, the vehicle industry is introducing a new concept of future mobility vision for realizing a human-centered, dynamic future city. One of these future mobility solutions is a Purpose Built Vehicle (PBV) as purpose-based mobility.

A PBV can be an example of an electric vehicle (EV)-based environment-friendly mobile vehicle. These PBVs can provide various customized services to users.

The vehicle body of the PBV has an upper body assembled to an under body. The upper body can be manufactured in various shapes depending on the type of customized service provided to the user.

However, if the structure of the upper body is developed separately depending on the type of customized service provided to the user as described above, the production cost may increase.

Accordingly, PBVs that can increase vehicle utilization while reducing production costs have been developed recently.

For example, a vehicle is being developed that has a common configuration for the cabin in the front part of the upper body including the driver's seat and underbody, and a configuration in which the rear part of the upper body can be changed according to the user's purpose.

Here, the front part of the vehicle can be defined as a fixed part (fixed portion) that is fixed to the front part of the underbody. Additionally, the rear part of the vehicle can be defined as a replaceable part (replaceable portion) manufactured in various shapes depending on the intended use of the vehicle.

Fixed parts are components that are not replaced even if the vehicle's intended use changes. And, the replaceable part is a component that can be replaced depending on the intended use of the vehicle, and can be combined with the fixed part and the rear part of the underbody, or separated from the fixed part and the rear part of the underbody.

To this end, the vehicle industry is focusing on discovering replaceable part exchange solutions that can easily replace replaceable parts depending on the vehicle's intended use.

The statements in this background section are merely provided to enhance understanding of the background of the present disclosure, and may include matters other than conventional art already known to a person of an ordinary skill in the field to which this art belongs.

### SUMMARY

The present disclosure provides a moving structure for a replaceable part and a moving system that enable the replaceable part to be moved along the forward and backward direction on an underbody so that the replaceable part can be easily replaced in the field depending on the intended use of the vehicle.

According to an embodiment of the present disclosure, a moving structure for a replaceable part of a vehicle is provided. The vehicle may include a fixed part fixed to an under body and a replaceable part that is detachable from the fixed part. According to an embodiment, the moving structure may include: replaceable part docking coupling members connected to lower sides on both sides of the replaceable part in a width direction of the vehicle; replaceable part guide units installed in the under body and configured to guide the replaceable part along the front and rear direction of a vehicle body by docking connection with the replaceable part docking coupling members along a vertical direction of the vehicle; and a rack gear mounted on a lower part of the replaceable part and positioned along the front and rear direction of the vehicle body.

Each of the replaceable part guide units may include a rail block connected to both sides of the under body and arranged along the front and rear direction of the vehicle body, a sliding block slidably connected to the rail block, and a body docking coupling member connected to the sliding block so as to be docking connected to the replaceable part docking coupling member along the vertical direction.

Each of the replaceable part guide units may further include a stopper connected to each of the front and rear ends of the rail block.

According to an embodiment, the moving structure may further include an elastic portion disposed between the stopper connected to the front end of the rail block and the body docking coupling member.

Each of the replaceable part docking coupling members may include a replaceable part docking shank connected to the replaceable part through a first flange portion and having a docking hole extending from a bottom to a top of the replaceable part docking shank.

The body docking coupling member may include a body docking shank connected to the sliding block through a second flange portion and having a taper-shaped docking protrusion docked to the docking hole.

According to an embodiment of the present disclosure, a replaceable part moving system for replaceable part of a vehicle may include the moving structure discussed above. In an embodiment, the replaceable part moving system may include a station frame on which the vehicle is positioned, and a drive gear module installed in the station frame so as to be selectively gear-engaged with the rack gear arranged along the front and rear direction on the replaceable part of the vehicle. The drive gear module may be installed along the width direction on the station frame and is movable in the vertical direction.

According to an embodiment, the replaceable part moving system may further include a lift unit installed in the station frame and connected to the drive gear module to move the drive gear module in the vertical direction in a position corresponding to the rack gear.

The drive gear module may include a base plate placed on the station frame, a gear driving servo motor installed on the base plate, and, a pinion gear connected to the gear driving servo motor and configured to selectively engage the rack gear.

The lift unit may include a lift driving servo motor fixed to the station frame, and a lead screw that is rotatably installed on the station frame, connected to the lift driving servo motor, and screw connected to the base plate. The lift unit may further include a guide rod that is fixed to the station frame and fitted into the base plate.

The vehicle may be a PBV (Purpose Built Vehicle) of which the replaceable parts is replaced by the replaceable part replacement system.

According to the moving structure for a replaceable part and the replaceable part moving system, a replaceable part that can be changed depending on the purpose of use can be easily replaced in the field, and interference between the replaceable part and surrounding parts can be avoided when replacing the replaceable part.

In addition, the effects that can be obtained or expected from embodiments of the present disclosure are directly or implicitly disclosed in the detailed description of the embodiments of the present disclosure. That is, various effects predicted according to embodiments of the present disclosure will be disclosed in the detailed description to be provided later.

### BRIEF DESCRIPTION OF THE DRAWINGS

Since these drawings are for reference in explaining embodiments of the present disclosure, the technical idea of the present disclosure should not be construed as being limited to the accompanying drawings.

FIG. 1 is a block diagram illustrating an example of a vehicle to which embodiments of the present disclosure can be applied.

FIG. 2 is an exploded perspective view of a vehicle to which a moving structure for a replaceable part can be applied according to an embodiment.

FIG. 3 is a side view of a vehicle to which a moving structure for a replaceable part according to an embodiment can be applied.

FIG. 4 and FIG. 5 are perspective views illustrating a replaceable part docking coupling member and a replaceable part guide unit applied to a moving structure for a replaceable part according to an embodiment.

FIG. 6A and FIG. 6B are cross-sectional views illustrating a replaceable part docking coupling member and a replaceable part guide unit applied to a moving structure for a replaceable part according to an embodiment.

FIG. 7 is a perspective view illustrating a rack gear applied to a moving structure for a replaceable part according to an embodiment.

FIG. 8 is a perspective view illustrating a replaceable part moving system according to an embodiment.

FIG. 9A and FIG. 9B are cross-sectional views illustrating a replaceable part moving system according to an embodiment.

FIGS. 10A-10D and FIGS. 11-13 are drawings for explaining the operation of a moving structure for a replaceable part and a moving system according to an embodiment.

### DESCRIPTION OF SYMBOLS

1: under body
3: upper body
10: vehicle
11: fixed part
12: replaceable part
15: joint unit
20: replaceable part replacement system
21: replaceable part transfer apparatus
30: replaceable part docking coupling member
31: replaceable part docking shank
33: first flange portion
35: docking hole
50: replaceable part guide unit
51: mount block
53: rail block
55: sliding block
57: body docking coupling member
59: stopper
61: elastic portion
63: body docking shank
65: second flange portion
67: docking protrusion
69: mounting bracket
70: rack gear
71: fixing bracket
100: moving structure for a replaceable part
110: station frame
111: caster
130: drive gear module
131: base plate
133: gear driving servo motor
135: pinion gear
150: lift unit
151: lift driving servo motor
153: lead screw
155: gear part
157: guide rod
200: replaceable part moving system

The drawings referenced above are not necessarily drawn to scale, but should be understood as presenting a somewhat simplified representation of various features illustrating the basic principles of the present disclosure. The specific design features of the present disclosure, including, for example, specific dimensions, orientation, location, and shape, will be determined in part by the particular intended application and usage environment.

### DETAILED DESCRIPTION

Hereinafter, with reference to the attached drawings, embodiments of the present disclosure are described in detail so that those having ordinary skill in the art can easily implement the present disclosure.

As those having ordinary skill in the art would realize, the described embodiments may be modified in various different ways, all without departing from the spirit or scope of the present disclosure.

The terminology used herein is for the purpose of describing particular embodiments only and is not intended to limit the present disclosure. As used herein, the singular forms are intended to include the plural forms as well, unless the context clearly indicates otherwise.

It should also be understood that the terms “comprises” and/or “comprising” as used herein indicate the presence of stated features, integers, steps, operations, elements and/or components, but do not preclude the presence or addition of one or more other features, integers, steps, operations, components, and/or groups thereof.

As used herein, the term ‘and/or’ includes any and all combinations of one or more of the associated listed items.

The term ‘connected’ in this specification denotes a physical relationship between two components that are directly connected to each other or indirectly connected through one or more intermediary components.

Furthermore, as used herein, the term “operably connected” or similar terms means that at least two members are directly or indirectly connected to each other so as to be capable of transmitting power. However, two operatively connected members do not always rotate at the same speed and in the same direction. When a component, device, element, or the like of the present disclosure is described as having a purpose or performing an operation, function, or the like, the component, device, or element should be considered herein as being “configured to” meet that purpose or to perform that operation or function.

As used herein, ‘vehicle’, ‘vehicular’, ‘automotive’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources).

Hereinafter, embodiments of the present disclosure are described in detail with reference to the attached drawings.

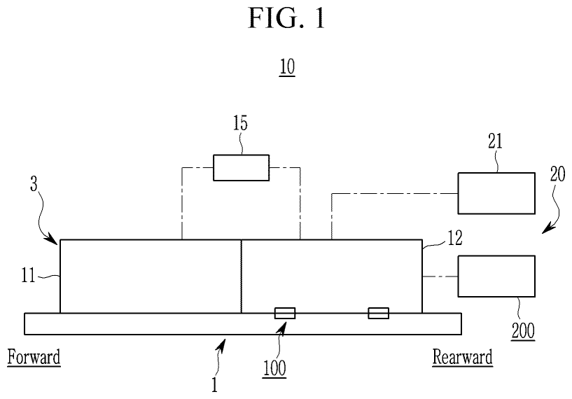

FIG. 1 is a block diagram illustrating an example of a vehicle to which embodiments of the present disclosure can be applied.

Referring to FIG. 1, a vehicle 10, to which embodiments of the present disclosure may be applied, may, for example, be a purpose-based mobility vehicle (Purpose Built Vehicle: hereinafter referred to as ‘PBV’).

The vehicle body of such a PBV includes a skateboard type under body 1 (commonly referred to as a ‘rolling chassis’ or ‘chassis frame’ by those having ordinary skill in the art) and an upper body 3 assembled to the under body 1.

The upper body 3 may be configured in various shapes depending on the intended use of the PBV.

For example, the PBV can be used as a hailing vehicle or a high roof vehicle with cabins configured in the front and rear of the upper body, respectively.

The PBV can also be used as a delivery vehicle with a cabin in the front part of the upper body and a luggage room in the rear part.

The PBV can be used as a pick-up vehicle or chassis cap vehicle with a cabin in the front and a deck in the rear.

In the present disclosure, the reference direction for describing the components below may be set as the front-rear direction of the vehicle 10 (e.g., the length direction or longitudinal direction of the vehicle), the vehicle width direction of the vehicle 10 (e.g., the transverse direction), and the vehicle vertical direction (e.g., the height direction or up down direction).

In this specification, ‘upper end’, ‘upper portion’, or ‘upper surface’ of a component indicates an end, portion, or surface of a component that is relatively upper in the drawing, and ‘lower end’, ‘lower portion’, or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The vehicle 10 (e.g., PBV), to which embodiments of the present disclosure may be applied, includes the upper body 3 assembled to the under body 1, and includes a fixed part (11, fixed portion) and a replaceable part (12, replaceable portion).

The fixed part 11 is the front part of the upper body 3 and is fixed to the front part of the under body 1. The fixed part 11 includes a front cabin of the cab type.

The fixed part 11 can be attached to the front part of the under body 1, along the vertical direction, via a vehicle body mounting unit known to those having ordinary skill in the art. The fixed part 11 here is defined in the embodiments and claims of the present disclosure as a structure that is not replaced even if the intended use of vehicle 10 changes.

The replaceable part 12 is the rear part of the upper body 3 and can be manufactured in various shapes depending on the intended use of the vehicle 10.

For example, the replaceable part 12 includes a rear cabin, luggage room, or deck. The replaceable part 12 is defined in the embodiments and claims as a replaceable component depending on the intended use of the vehicle 10.

The replaceable part 12 can be connected to the rear part of under body 1 and fixed part 11 by a joint unit 15, or can be separated from the rear part of under body 1 and fixed part 11.

The joint unit 15 can be configured for various types of connections, such as a configuration that is manually connected by a mechanical configuration, a configuration that is connected by the operation of a separate actuator, and a configuration that can be connected and/or released depending on the supply of external or internal power, including magnetic, etc. The configuration and operation of the joint unit 15, which connects or disconnects one or more modules or frames, are obvious to those having ordinary skill in the art, and thus a detailed description is omitted.

The replaceable part 12 of the vehicle 10, to which embodiments of the present disclosure may be applied, may be replaced by a replaceable part replacement system 20 at a field work site (e.g., a replaceable part exchange location) depending on the intended use of the vehicle 10.

The replaceable part replacement system 20 can move the replaceable part 12 rearwardly and move the replaceable part 12 to a predetermined location while the fixed part 11 and the replaceable part 12 are disconnected by the joint unit 15 and the under body 1 and the replaceable part 12 are disconnected.

Additionally, the replaceable part replacement system 20 can load another replaceable part 12, which is supplied separately, onto the under body 1 at a predetermined location and move the other replaceable part 12 forward.

To enable replacement of the replaceable part 12 using the replaceable part replacement system 20, embodiments of the present disclosure provide a moving structure for a replaceable part 100 as a vehicle body structure in which the replaceable part 12 is movable in the forward-backward direction on the under body 1.

Furthermore, embodiments of the present disclosure provide a replaceable part moving system 200 configured to move the replaceable part 12 along the forward-backward direction of the vehicle body on the under body 1 when replacing the replaceable part 12.

The replaceable part replacement system 20 applicable to embodiments of the present disclosure above includes a replaceable part transfer apparatus 21 for lifting a replaceable part 12 and transferring it to a predetermined position, and the replaceable part moving system 200 according to an embodiment.

The replaceable part transfer apparatus 21 may be provided as a structure capable of lifting or lowering the replaceable part 12 to a predetermined position, for example, in a lift manner or a hoist manner.

Below, the moving structure for a replaceable part 100 according to an embodiment will be described.

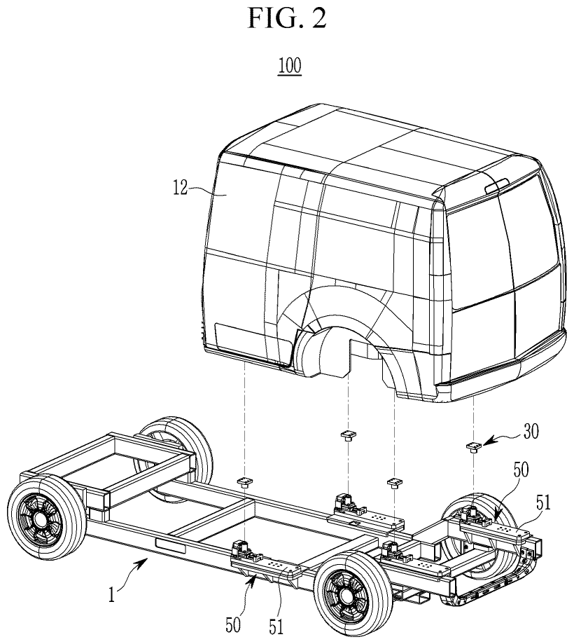

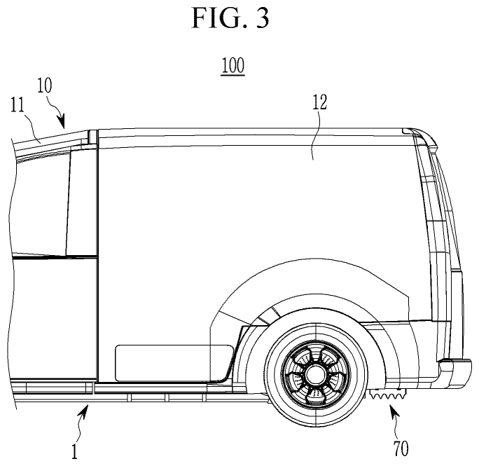

FIG. 2 is an exploded perspective view of a vehicle to which a moving structure for a replaceable part can be applied according to an embodiment, and FIG. 3 is a side view of a vehicle to which a moving structure for a replaceable part according to an embodiment can be applied.

Referring to FIG. 1 to FIG. 3, an embodiment of the moving structure for the replaceable part 100 includes replaceable part docking coupling members 30, replaceable part guide units 50, and a rack gear 70.

In an embodiment, the replaceable part docking coupling members 30 are connected to the lower sides of both sides along the vehicle width direction of the replaceable part 12.

The replaceable part docking coupling members 30 can, in one example, be mounted at predetermined points on the lower sides of the replaceable part 12.

In an embodiment, the replaceable part guide units 50 are configured to be docked connected to the replaceable part docking coupling members 30 along a vertical direction.

In addition, the replaceable part guide units 50 are configured to guide the replaceable part 12 along the forward and backward direction of the vehicle body while being docked to the replaceable part docking coupling members 30.

The replaceable part guide units 50 are installed in predetermined positions, such as four positions, on the under body 1 at positions corresponding to the replaceable part docking coupling members 30. These replaceable part guide units 50 can be mounted to the under body 1 via mount blocks 51.

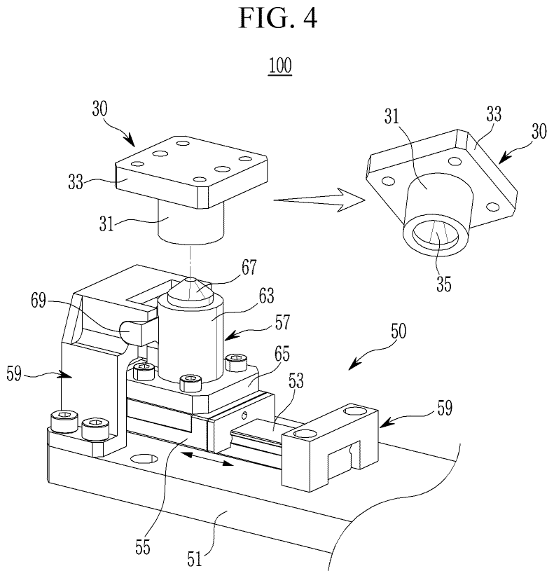

The configuration of the replaceable part docking coupling members 30 and the replaceable part guide units 50 according to an embodiment of the present disclosure is described in detail referring to FIG. 4 to FIG. 6B.

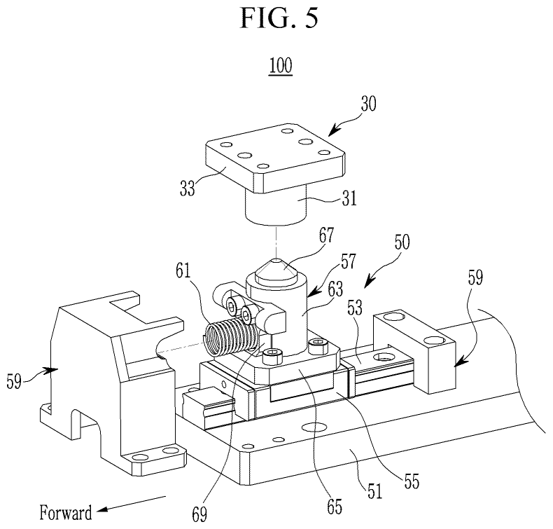

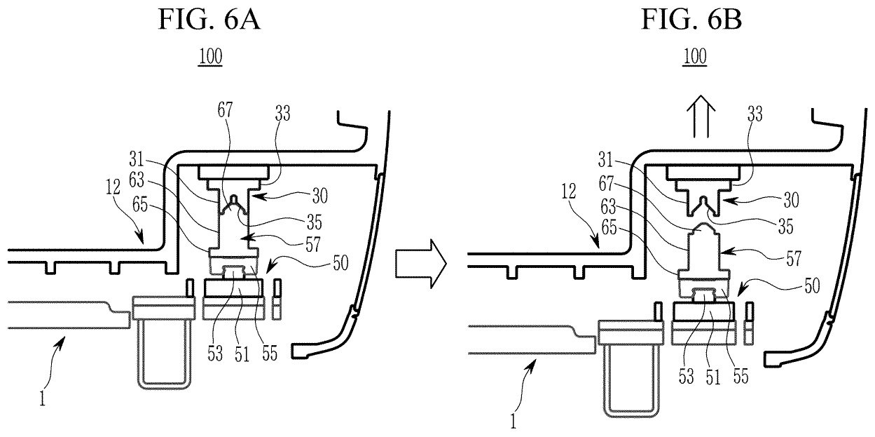

FIG. 4 and FIG. 5 are perspective views illustrating a replaceable part docking coupling member and a replaceable part guide unit applied to a moving structure for a replaceable part according to an embodiment. FIG. 6A and FIG. 6B are cross-sectional views illustrating a replaceable part docking coupling member and a replaceable part guide unit applied to a moving structure for a replaceable part according to an embodiment.

Referring to FIG. 4 to FIG. 6B, each of the replaceable part docking coupling members 30 according to an embodiment includes a replaceable part docking shank 31.

The replaceable part docking shank 31 is connected to the lower part of replaceable part 12 via a first flange portion 33. The replaceable part docking shank 31 include a docking hole 35 extending upward from the bottom.

According to an embodiment, each of the replaceable part guide units 50 includes a rail block 53, a sliding block 55, a body docking coupling member 57, a stopper 59, and an elastic portion 61.

The rail block 53 is connected to both sides of the vehicle width direction of the under body 1. The rail block 53 is connected to the mount block 51 mounted on the under body 1 and is arranged along the front and rear direction of the under body 1.

The sliding block 55 is slidably connected to the rail block 53 along the front and rear direction of the under body 1.

The body docking coupling member 57 is configured to dock along the vertical direction with the replaceable part docking shank 31 of the replaceable part docking coupling members 30.

The body docking coupling member 57 is connected to the sliding block 55. The body docking coupling member 57 includes a body docking shank 63.

The body docking shank 63 is connected to the sliding block 55 via a second flange portion 65. The body docking shank 63 includes a docking protrusion 67 capable of being docked along a vertical direction to the docking hole 35 of the replaceable part docking shank 31.

The docking protrusion 67 can be formed into a taper shape to compensate for the position dispersion of the replaceable part docking coupling members 30 when connected to the docking hole 35 of the replaceable part docking shank 31.

In other words, the docking protrusion 67 can be formed into a shape in which the cross-section gradually becomes smaller from the bottom to the top. In addition, the docking hole 35 corresponding to the docking protrusion 67 can also be formed in a shape with a cross-section that gradually gets smaller from the bottom to the top.

The stopper 59 is designed to limit the movement range of the sliding block 55 in the front to rear direction. The stopper 59 is provided in block form and is connected to the front and rear ends of the rail block 53, respectively.

Additionally, the elastic portion 61 provides elastic force to the body docking coupling member 57 and is configured to compensate for the position dispersion of the body docking coupling member 57.

The elastic portion 61 is arranged between the stopper 59 connected to the forward end of the rail block 53 and the body docking coupling member 57.

One end of the elastic portion 61 is connected to the stopper 59. And, the other end of the elastic portion 61 is connected to a mounting bracket 69 connected to a body docking shank 63.

Here, the elastic portion 61 is compressed when the sliding block 55 moves forward along the rail block 53, and is tensioned when the sliding block 55 moves rearward.

The elastic portion 61 may be, for example, a compression coil spring.

In an embodiment, referring to FIG. 3, the rack gear 70 is arranged along the front to rear direction at the rear lower portion of the replaceable part 12.

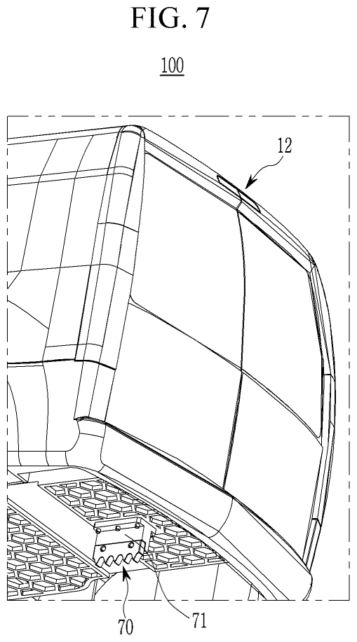

The rack gear 70 can be mounted on the lower part of the replaceable part 12, as shown in FIG. 7. The rack gear 70 can be fixed to the rear bottom surface of the replaceable part 12 via a fixing bracket 71.

The operation of the rack gear 70 as described above is described below together with the replaceable part moving system 200 according to an embodiment.

Referring to FIG. 1, the replaceable part moving system 200 is configured to move the replaceable part 12 in a front and rear direction when replacing the replaceable part 12 of a vehicle 10 having the moving structure for a replaceable part 100 as described above using a replaceable part transfer apparatus 21.

According to an embodiment, the replaceable part moving system 200 may move the replaceable part 12 rearward before lifting the replaceable part 12, which is disconnected from the fixed part 11 and the under body 1, via the replaceable part transfer apparatus 21.

According to an embodiment, the replaceable part moving system 200 can load another replaceable part 12 into the under body 1 of the vehicle 10 from which the replaceable part 12 has been removed, and move the other replaceable part 12 forward before the other replaceable part 12 is connected to the fixed part 11 and/or the under body 1 by the joint unit 15.

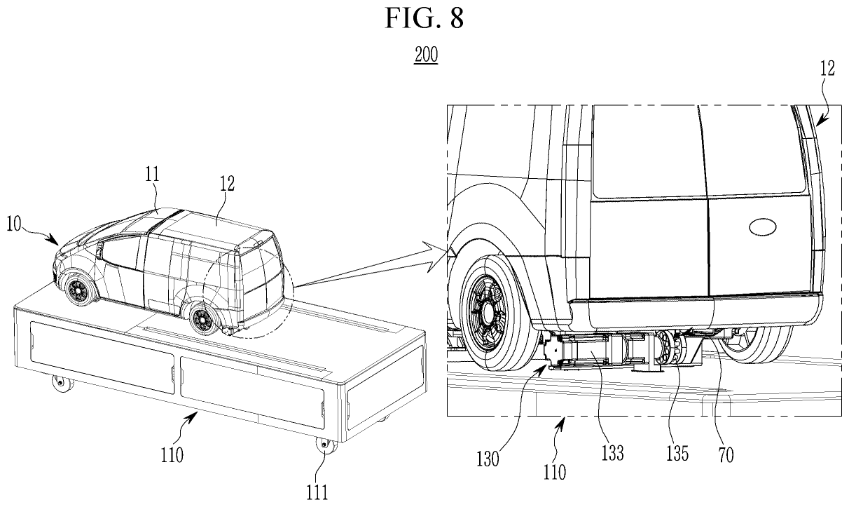

FIG. 8 is a perspective view illustrating a replaceable part moving system according to an embodiment.

Referring to FIG. 1 and FIG. 8, the replaceable part moving system 200, according to an embodiment, includes a station frame 110 and a drive gear module 130.

The station frame 110 is configured to support various components described below.

The station frame 110 may include one frame or two or more connected frames, and may also be composed of a box-shaped frame as shown in the drawing.

In addition, the station frame 110 may include various auxiliary elements such as rods (or beams), plates, brackets, and blocks to support various components.

However, since the above-mentioned various auxiliary elements are for installing various components in the station frame 110, in an embodiment, except in exceptional cases, the above-mentioned auxiliary elements are collectively referred to as the station frame 110.

The station frame 110 is configured to position the vehicle 10 that has been brought into the field work area (e.g., replaceable part exchange location).

The vehicle 10 is positioned on the station frame 110 with the fixed part 11 fixed to the front part of the under body 1 (see FIG. 3) and the replaceable part 12 connected to the rear part of the under body 1 and the fixed part 11 by the joint unit 15 (see FIG. 1).

The station frame 110 like this can, in one example, be fixed in a static manner to a field work site. In another example, the station frame 110 may be freely moved within the field work area by a plurality of casters 111 mounted on its lower portion, as shown in the drawing.

In an embodiment, the drive gear module 130 may be an actuator for generating force to move the replaceable part 12 in a front and rear direction and providing force to the replaceable part 12.

The drive gear module 130 is configured to selectively engage the rack gear 70 arranged along the front and rear direction in replaceable part 12. The drive gear module 130 is installed in the station frame 110 and is arranged along the vehicle width direction.

In one example, the drive gear module 130 may be secured to the station frame 110, as shown in FIG. 8. In this case, the drive gear module 130 may engage the rack gear 70 of replaceable part 12 when the vehicle 10 moves rearward on the station frame 110.

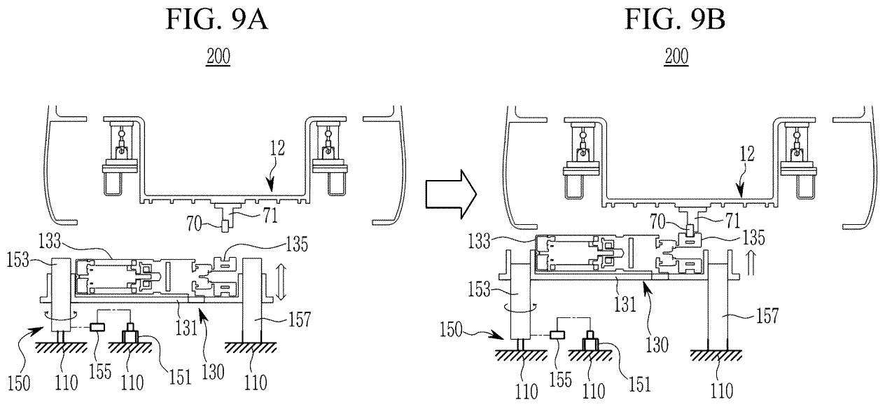

FIG. 9A and FIG. 9B are cross-sectional views illustrating a replaceable part moving system according to an embodiment.

Referring to FIG. 9A and FIG. 9B, the drive gear module 130 may be installed movably in the vertical direction in the station frame 110, in another example.

This drive gear module 130 may be moved in the vertical direction by the lift unit 150.

According to an embodiment, the drive gear module 130 includes a base plate 131, a gear driving servo motor 133 and a pinion gear 135.

The base plate 131 is arranged, along the vehicle width direction, on the station frame 110.

The gear driving servo motor 133 is a motor capable of servo control of rotating direction and rotation speed, and is fixed to the base plate 131.

Additionally, the pinion gear 135 is operationally connected to the gear driving servo motor 133 and selectively engages the rack gear 70 of the replaceable part 12.

The lift unit 150 according to the above embodiment is configured to move the drive gear module 130 in the vertical direction at a position corresponding to the rack gear 70.

The lift unit 150 is installed in station frame 110 and is operationally connected to the drive gear module 130.

The lift unit 150 includes a lift driving servo motor 151, a lead screw 153, and a guide rod 157.

The lift driving servo motor 151 is a motor capable of servo control of rotating direction and rotation speed and is fixed to the station frame 110.

For example, the lift driving servo motor 151 may be installed inside the station frame 110 if the station frame 110 is a box type frame.

The lead screw 153 is rotatably installed in the station frame 110 and connected to the lift driving servo motor 151. The lead screw 153 is screw connected to the base plate 131.

The lead screw 153 may be operationally connected to the lift driving servo motor 151 via gear part 155.

The lead screw 153 may be rotatably installed in the station frame 110. These lead screws 153 may be screw connected to the base plate 131.

The guide rod 157 is fixed to the station frame 110 to guide the up and down movement of the base plate 131. The guide rod 157 is fitted into the base plate 131.

Hereinafter, the operation of the moving structure for a replaceable part 100 and a replaceable part moving system 200 according to an embodiment configured as described above will be described in detail with reference to FIG. 1 to FIG. 13.

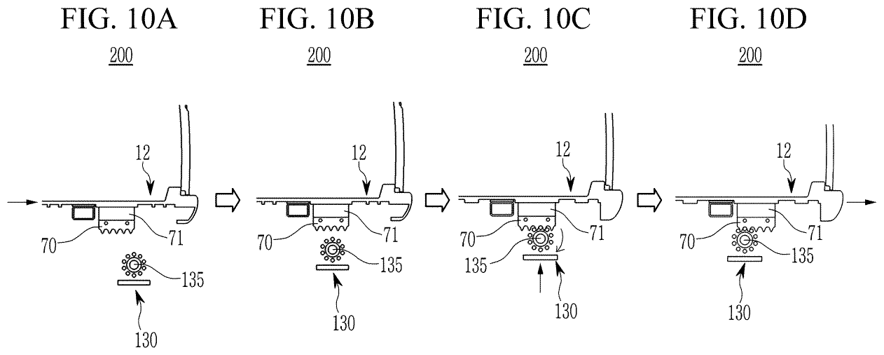

FIG. 10A to FIG. 13 are drawings for explaining the operation of a moving structure for a replaceable part and a moving system according to an embodiment.

Referring to FIG. 1 to FIG. 9B, in an embodiment, the vehicle 10 is brought into a field work location (e.g., a replaceable part exchange location).

The fixed part 11 of the vehicle 10 is fixed to the front part of the under body 1, and the replaceable part 12 is connected to the fixed part 11 and the rear part of the under body 1 by the joint unit 15.

Such vehicle 10 may be a hailing vehicle or a high roof vehicle each including a cabin on the fixed part 11 and the replaceable part 12.

Additionally, the vehicle 10 may be a delivery vehicle having a cabin formed to the fixed part 11 and a luggage room formed to the replaceable part 12.

Alternatively, the vehicle 10 may be a pickup vehicle or chassis cab vehicle having a cabin formed to the fixed part 11 and a deck formed to the replaceable part 12.

The replaceable part 12 of the vehicle 10 as described above can be replaced by the replaceable part replacement system 20 in a field workshop.

To this end, the vehicle 10 enters the station frame 110 and positions itself at a set position in the station frame 110.

Next, the connection between the fixed part 11 and the replaceable part 12 by the joint unit 15, and the connection between the under body 1 and the replaceable part 12 are released.

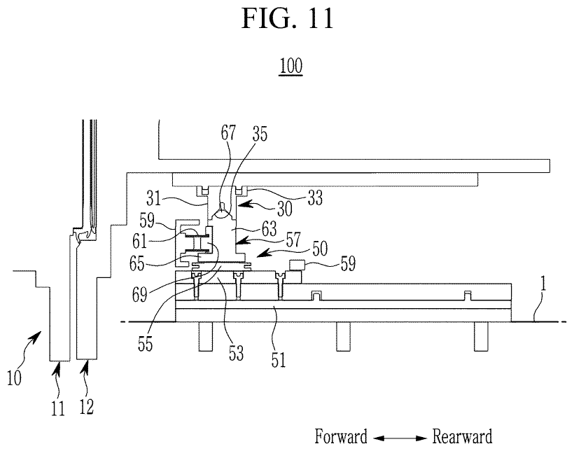

As shown in FIG. 11, the sliding block 55, to which the body docking coupling member 57 of the replaceable part guide units 50 is connected, is moved forward along the rail block 53 on the under body 1.

That is, the sliding block 55 compresses the elastic portion 61 between the stopper 59 and the body docking coupling member 57 and is in a forwardly moved state.

And, the replaceable part docking coupling members 30 connected to the replaceable part 12 are docked connected to the body docking coupling member 57 (see FIG. 6 and FIG. 11).

The docking protrusion 67 of the body docking shank 63 of the body docking coupling member 57 is docked connected along the vertical direction to the docking hole 35 of the replaceable part docking shank 31 of the replaceable part docking coupling members 30.

The drive gear module 130 is moved downward by the lift unit 150 to a position corresponding to the rack gear 70 of the replaceable part 12 (see FIG. 9A and FIG. 10A).

In this state, the drive gear module 130 moves upward by the lift unit 150 (see FIG. 10B).

When the lift driving servo motor 151 of the lift unit 150 operates, the lead screw 153 screw-connected to the base plate 131 rotates. Accordingly, as the base plate 131 moves upward along the guide rod 157, the entire drive gear module 130 can move upward.

As the drive gear module 130 moves in the upward direction, the pinion gear 135 of the drive gear module 130 engages the rack gear 70 of the replaceable part 12 (see FIG. 9B and FIG. 10C).

Next, as shown in FIG. 10C, the gear driving servo motor 133 of the drive gear module 130 is operated. Then, the pinion gear 135 rotates in one direction and moves the replaceable part 12 rearward from the fixed part 11 via the rack gear 70 (see FIG. 10D).

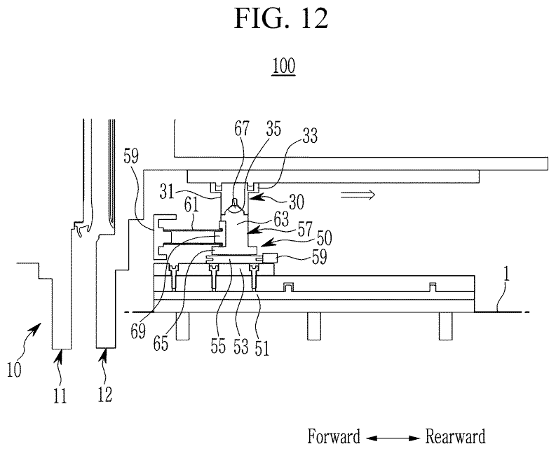

In this process, as shown in FIG. 12, the sliding block 55 moves rearward along the rail block 53. At this time, the elastic portion 61, which was compressed between the stopper 59 and the body docking coupling member 57, is released.

Since the replaceable part docking coupling members 30 connected to the replaceable part 12 are docked connected to the body docking coupling members 57 connected to the sliding block 55, the replaceable part 12 moves rearward from the fixed part 11 along the rail block 53 by the sliding block 55.

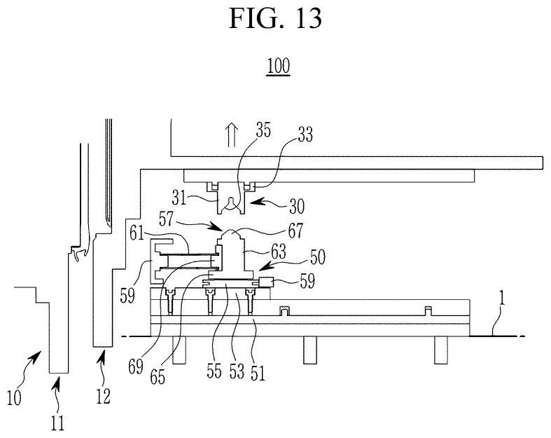

In this state, the replaceable part 12 is lifted upward from the under body 1 by the replaceable part transfer apparatus 21 as shown in FIG. 13. Accordingly, the replaceable part docking coupling members 30 and the body docking coupling member 57 are separated from each other along the vertical direction, thereby releasing their docking connection.

The replaceable part 12, lifted by the replaceable part transfer apparatus 21, is moved to a predetermined location.

The replaceable part transfer apparatus 21 loads another replaceable part 12, which is supplied separately, onto the under body 1 at a predetermined location.

The replaceable part docking coupling members 30 and the body docking coupling member 57 are docked and connected along the vertical direction as shown in FIG. 13.

At this time, as shown in FIG. 9A, the drive gear module 130 is moved downward by the lift unit 150 to a position corresponding to the rack gear 70 of another replaceable part 12.

Next, as shown in FIG. 9B, drive gear module 130 moves upward by the lift unit 150.

To explain the lowering motion of the above drive gear module 130, when the lift driving servo motor 151 of the lift unit 150 operates, the lead screw 153 screw-connected to the base plate 131 rotates in the other direction. Accordingly, as the base plate 131 moves downward along the guide rod 157, the entire drive gear module 130 may move downward.

As the drive gear module 130 moves upward as described above, the pinion gear 135 engages with the rack gear 70 of another replaceable part 12.

Afterwards, when the gear driving servo motor 133 of the drive gear module 130 operates, the pinion gear 135 rotates in the reverse direction and moves another replaceable part 12 forward toward the fixed part 11 through the rack gear 70.

Here, as shown in FIG. 11, the sliding block 55, to which the body docking coupling member 57 is connected, moves forward along the rail block 53 on the under body 1.

In this state, the other replaceable part 12 may be connected to the rear part of the under body 1 and the fixed part 11 by the joint unit 15.

The moving structure for a replaceable part 100 and the replaceable part moving system 200 according to an embodiment described so far can move the replaceable part 12 in a front to rear direction so that the replaceable part 12, which can be changed depending on the intended use of the vehicle 10, can be easily replaced in the field.

Therefore, replaceable part 12 can be replaced without interfering with surrounding parts by means of the moving structure for a replaceable part 100 and the replaceable part moving system 200 according to an embodiment.

Accordingly, the moving structure for a replaceable part 100 and the replaceable part moving system 200 according to an embodiment can improve the replacement workability of the replaceable part 12 and contribute to standardization of the replaceable part replacement solution and securing a competitive edge.

Although the embodiments of the present disclosure have been described above, the present disclosure is not limited thereto, and various modifications May be made within the scope of the claims, the detailed description of the present disclosure, and the attached drawings, which also fall within the scope of the present disclosure.

What is claimed is:

1. A moving structure for a replaceable part of a vehicle, including a fixed part fixed to an under body and a replaceable part that is detachable from the fixed part, the moving structure comprising:
replaceable part docking coupling members connected to lower sides on both sides of the replaceable part in a width direction of the vehicle;
replaceable part guide units installed in the under body and configured to guide the replaceable part, along a front and rear direction of a vehicle body, by docking connection with the replaceable part docking coupling members along a vertical direction of the vehicle; and
a rack gear mounted on a lower part of the replaceable part and positioned along the front and rear direction of the vehicle body.

2. The moving structure of claim 1, wherein each of the replaceable part guide units comprising:
a rail block connected to both sides of the under body and arranged along the front and rear direction of the vehicle body;
a sliding block slidably connected to the rail block; and,
a body docking coupling member connected to the sliding block so as to be docking connected to the replaceable part docking coupling member along the vertical direction.

3. The moving structure of claim 2, wherein each of the replaceable part guide units further comprises a stopper connected to each of front and rear ends of the rail block.

4. The moving structure of claim 3, further comprising an elastic portion disposed between the stopper connected to the front end of the rail block and the body docking coupling member.

5. The moving structure of claim 2, wherein each of the replaceable part docking coupling members comprises a replaceable part docking shank connected to the replaceable part through a first flange portion and having a docking hole extending from a bottom to a top of the replaceable part docking shank.

6. The moving structure of claim 5, wherein the body docking coupling member comprises a body docking shank connected to the sliding block through a second flange portion and having a taper-shaped docking protrusion docked to the docking hole.

7. A replaceable part moving system including the moving structure of claim 1, the replaceable part moving system comprising:
a station frame on which the vehicle is positioned; and
a drive gear module installed in the station frame so as to be selectively gear-engaged with the rack gear arranged along the front and rear direction on the replaceable part of the vehicle.

8. The replaceable part moving system of claim 7, wherein the drive gear module is installed along the width direction on the station frame and is movable in the vertical direction.

9. The replaceable part moving system of claim 7, further comprising a lift unit installed in the station frame and connected to the drive gear module to move the drive gear module in the vertical direction in a position corresponding to the rack gear.

10. The replaceable part moving system of claim 9, wherein the drive gear module comprises:
a base plate placed on the station frame;
a gear driving servo motor installed on the base plate; and,
a pinion gear connected to the gear driving servo motor and configured to selectively engage the rack gear.

11. The replaceable part moving system of claim 10, wherein the lift unit comprises:
a lift driving servo motor fixed to the station frame;
a lead screw that is rotatably installed on the station frame, connected to the lift driving servo motor, and screw connected to the base plate; and,
a guide rod that is fixed to the station frame and fitted into the base plate.

12. The replaceable part moving system of claim 7, wherein the vehicle is a Purpose Built Vehicle (PBV) of which the replaceable parts is replaced by the replaceable part replacement system.
